(19) United States
(12) Patent Application Publication
(10) Pub. No.: US 2026/0268895 A1
(43) Pub. Date: Sep. 10, 2026

(54) SYSTEMS AND METHODS FOR GENERATING MACHINE-LEARNING TRAINING VECTORS FROM EXECUTION-ENVELOPE-DERIVED FIELD DATA

(71) Applicant: Andrew Doughty, Shalimar, FL (US)

(72) Inventor: Andrew Doughty, Shalimar, FL (US)

(21) Appl. No.: 19/645,668

(22) Filed: Apr. 13, 2026

Related U.S. Application Data
(63) Continuation-in-part of application No. 19/638,388, filed on Apr. 3, 2026.
Application No. 19/638,388 is a continuation of application No. 19/392,963, filed on Nov. 18, 2025.
Application No. 19/392,963 is a continuation-in-part of application No. 19/392,883, filed on Nov. 18, 2025.
Application No. 19/392,883 is a continuation-in-part of application No. 19/392,779, filed on Nov. 18, 2025.
Application No. 19/392,779 is a continuation-in-part of application No. 19/281,049, filed on Jul. 25, 2025.
Application No. 19/281,049 is a continuation-in-part of application No. 19/075,101, filed on Mar. 10, 2025.

(51) Int. Cl. G10L 13/08; H04L 9/30; H04W 4/029; H04W 84/18

(52) U.S. Cl. CPC G10L 13/08; H04L 9/3066; H04W 4/029; H04W 84/18

(57) ABSTRACT

A method comprising capturing an instruction delivered to a worker, wherein the instruction includes an instruction identifier, and establishing an intent datum representing information sufficient to establish what the worker is being asked to do. The method includes opening an execution window defining a bounded telemetry interval, capturing telemetry data during the execution window including motion data and spatial position data, and collecting corroborating signals during the execution window including at least one of witness signatures, workflow confirmations, tool state, interlock state, biometric state, or outcome tags. The method includes associating outcome data or exception data with the captured telemetry data and generating a labeled training vector linking the intent datum to the telemetry data and the corroborating signals, the labeled training vector including an intent field, an action field, a corroboration field, and an outcome/exception field.

### CROSS-REFERENCE TO RELATED APPLICATIONS

This application is a Continuation-in-Part Utility Patent application claiming priority to U.S. patent application Ser. No. 19/638,388, filed on Apr. 3, 2026, which claims priority to U.S. patent application Ser. No. 19/392,963, filed on Nov. 18, 2025, which claims priority to U.S. patent application Ser. No. 19/392,883, filed on Nov. 18, 2025, which claims priority to U.S. patent application Ser. No. 19/392,779, filed on Nov. 18, 2025, which claims priority to U.S. patent application Ser. No. 19/281,049, filed on Jul. 25, 2025, which claims priority to U.S. patent application Ser. No. 19/075,101, filed on Mar. 10, 2025, which are all incorporated by reference herein in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates to machine-learning training data generation, and more particularly to systems and methods for generating machine-learning training vectors from execution-envelope-derived field data, including transformation of execution-envelope data into labeled training vectors, generation of exception-tagged deviation records, and training of machine-learning models or autonomous control systems using aggregated intent-action-corroboration vectors.

### 2) Description of Related Art

Machine-learning systems and autonomous control systems may be trained using large datasets to perform classification, prediction, sequencing, recommendation, or control tasks. The quality and structure of training data can significantly influence the performance of the resulting trained models. In many domains, training data is derived from internet-sourced content, simulated environments, or manually curated datasets.

In field environments such as construction sites, manufacturing facilities, healthcare settings, and other work sites, workers perform physical tasks according to delivered instructions. Existing field systems generally capture isolated video, event logs, or self-reported task completion data. While such data may be useful for certain operational purposes, it often lacks the structured relationships between different categories of information that would make it suitable for training machine-learning models or autonomous control systems.

For example, existing approaches may capture that a task was completed, but may not preserve the relationship between the instruction that was delivered to a worker, the telemetry captured during the execution of that instruction, any corroborating signals associated with the execution event, and the resulting outcome or exception state. Without preserving these relationships in a structured form, the captured data may have limited utility as training input for machine-learning models or autonomous systems intended to govern physical task execution or operational decision-making.

Additionally, when workers deviate from delivered instructions due to changing conditions, safety considerations, or other factors, existing systems may not capture such deviation events in a manner that preserves the contextual information surrounding the deviation. This can limit the ability to use real-world worker adaptations as training examples for adaptive or exception-handling models.

Therefore, improved systems and methods for generating structured training data from field execution environments are desired.

### BRIEF SUMMARY OF THE INVENTION

According to an aspect of the present disclosure, a method of transforming platform-generated execution data into a machine-learning-ready vector is provided. The method includes capturing an instruction delivered to a worker wherein the system establishes an intent datum. The method includes passively capturing telemetry during the execution window for that task, including at least motion and spatial context. The method includes collecting corroborating signals such as witness signatures, workflow confirmations, tool/interlock state, biometric state, and/or outcome tags. The method includes transforming the platform-generated execution data into a unified labeled training vector that links instruction intent to physical action and associated verification data.

According to another aspect of the present disclosure, a method of using worker deviations, overrides, or bypasses as training examples is provided. The method includes detecting when a worker overrides a step, bypasses a safety interlock, or otherwise deviates from the delivered instruction. The method includes taking a contextual snapshot of the environmental, spatial, and procedural conditions at that moment. The method includes generating an exception-tagged deviation record. The method includes using the exception-tagged deviation record as a training example for a predictive model, enabling the system to learn how experienced humans adapt to changing real-world conditions.

According to another aspect of the present disclosure, a method of using a dataset downstream is provided. The method includes aggregating the structured training vectors across multiple workers, tasks, and sites. The method includes ingesting the structured training vectors into a machine-learning model or autonomous control system. The method includes training the model or control policy using the instruction-action-corroboration relationships preserved in the vectors.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a block diagram of an architecture for generating machine-learning training vectors from execution-envelope-derived field data, according to aspects of the present disclosure.

FIG. 2 illustrates a block diagram of an execution envelope serving as a source data primitive for training-vector generation, according to aspects of the present disclosure.

FIG. 3 illustrates a diagram of an execution-window timeline associated with a delivered instruction, according to aspects of the present disclosure.

FIG. 4 illustrates a block diagram of a system for transforming intent, telemetry, and corroborating signals into a labeled training vector, according to aspects of the present disclosure.

FIG. 5 illustrates a flowchart of a method for generating a machine-learning-ready training vector from execution-envelope-derived data, according to aspects of the present disclosure.

FIG. 6 illustrates a flowchart of a method for generating exception-tagged deviation training records, according to aspects of the present disclosure.

FIG. 7 illustrates a diagram of a structured exception-tagged deviation record generated from a worker deviation event, according to aspects of the present disclosure.

FIG. 8 illustrates a system diagram depicting aggregation of labeled training vectors into an execution training corpus, according to aspects of the present disclosure.

FIG. 9 illustrates a block diagram of a system for training a machine-learning model using an aggregated execution training corpus, according to aspects of the present disclosure.

FIG. 10 illustrates a block diagram of a governance layer and provenance layer associated with an execution training corpus, according to aspects of the present disclosure

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

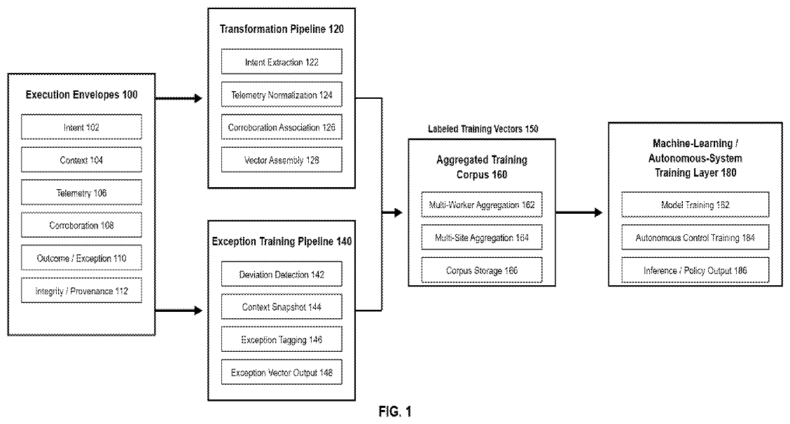

Referring to FIG. 1, the present disclosure describes systems and methods for generating machine-learning training vectors from execution-envelope-derived field data. The systems and methods transform platform-generated execution data into structured training vectors that link instruction intent to physical action and associated verification data. The transformation enables the generation of labeled training vectors 150 suitable for training machine-learning models or autonomous control systems.

Existing field systems capture isolated video, event logs, or self-reported task completion data in the management and execution of work at construction sites, manufacturing facilities, healthcare settings, and other work sites. Such existing systems do not preserve the relationship between instruction intent, execution-window telemetry, corroborating signals, and outcome state in a form suitable for machine-learning training or autonomous control. The systems and methods described herein address these limitations by generating structured training data that preserves, in a single record, the relationship between the instruction that was delivered, the execution window during which the worker acted, the telemetry captured during that window, the corroborating signals associated with that event, and the resulting outcome or exception state.

With continued reference to FIG. 1, execution envelopes 100 function as the source data primitive for a training-data pipeline. The execution envelopes 100 contain intent 102, context 104, telemetry 106, corroboration 108, outcome/exception 110, and integrity/provenance 112. A transformation pipeline 120 receives data from the execution envelopes 100 and processes the data through intent extraction 122, telemetry normalization 124, corroboration association 126, and vector assembly 128 to generate the labeled training vectors 150.

An exception training pipeline 140 handles deviation events when workers override, bypass, or otherwise deviate from delivered instructions. The exception training pipeline 140 includes deviation detection 142, context snapshot 144, exception tagging 146, and exception vector output 148. The exception training pipeline 140 generates exception-tagged deviation records that capture contextual information surrounding deviation events, enabling the use of real-world worker adaptations as training examples for adaptive or exception-handling models.

The labeled training vectors 150 flow into an aggregated training corpus 160, which includes multi-worker aggregation 162, multi-site aggregation 164, and corpus storage 166. The aggregated training corpus 160 provides input to a machine-learning/autonomous-system training layer 180, which includes model training 182, autonomous control training 184, and inference/policy output 186. The machine-learning/autonomous-system training layer 180 trains machine-learning models and autonomous control systems using the instruction-action-corroboration relationships preserved in the training vectors.

Referring to FIG. 1, an architecture for generating machine-learning training vectors from execution-envelope-derived field data includes execution envelopes 100, a transformation pipeline 120, an exception training pipeline 140, labeled training vectors 150, an aggregated training corpus 160, and a machine-learning/autonomous-system training layer 180. The architecture transforms platform-generated execution data into structured training vectors that link instruction intent to physical action and associated verification data.

The execution envelopes 100 function as the source data primitive for the training-data pipeline. Each execution envelope within the execution envelopes 100 is a bounded execution-context record for a discrete work event that captures the delivered instruction, associated context, telemetry, corroborating signals, outcome state, and integrity/provenance information. The execution envelopes 100 contain intent 102, context 104, telemetry 106, corroboration 108, outcome/exception 110, and integrity/provenance 112. The intent 102 represents the instruction delivered to a worker, including at least an instruction identifier or other information sufficient to establish what the worker was being asked to do. The context 104 captures situational information surrounding the execution event, including location, time, worker role, and environmental conditions. The telemetry 106 includes sensor data, motion data, and spatial positioning information captured during the execution window. The corroboration 108 includes signals associated with the execution event that support confidence in the recorded context or action, such as witness signatures, workflow confirmations, tool/interlock state, biometric state, or outcome tags. The outcome/exception 110 captures the result of the work event, including completion state and any deviation information. The integrity/provenance 112 provides traceability and validation information for the record. With continued reference to FIG. 1, the transformation pipeline 120 receives data from the execution envelopes 100 and processes the data through multiple stages to generate the labeled training vectors 150. The transformation pipeline 120 includes intent extraction 122, telemetry normalization 124, corroboration association 126, and vector assembly 128. Intent extraction 122 extracts instruction intent from the source data contained in the execution envelopes 100. Telemetry normalization 124 normalizes the captured telemetry data into a standardized format suitable for machine-learning applications. Corroboration association 126 associates corroborating signals with the execution data, linking supporting evidence to the corresponding execution events. Vector assembly 128 assembles the processed data into structured training vectors that preserve the relationship between instruction intent, captured telemetry, corroborating signals, and outcome information.

The exception training pipeline 140 receives data from the execution envelopes 100 and handles deviation events when workers override, bypass, or otherwise deviate from delivered instructions. The exception training pipeline 140 includes deviation detection 142, context snapshot 144, exception tagging 146, and exception vector output 148. Deviation detection 142 detects when a worker overrides a step, bypasses a safety interlock, or otherwise deviates from the delivered instruction. Context snapshot 144 captures a contextual snapshot of the environmental, spatial, and procedural conditions at the moment of deviation. Exception tagging 146 generates exception tags for the deviation records, identifying the events as exception-type training examples. Exception vector output 148 produces exception-tagged deviation records that capture contextual information surrounding deviation events. The output of the exception training pipeline 140 feeds into the labeled training vectors 150, enabling the use of real-world worker adaptations as training examples for adaptive or exception-handling models.

As further shown in FIG. 1, the labeled training vectors 150 flow into the aggregated training corpus 160. The labeled training vectors 150 are structured, labeled data records generated from execution-envelope-derived data that link instruction intent to captured telemetry, corroborating signals, and associated outcome information for use in machine learning. The aggregated training corpus 160 includes multi-worker aggregation 162, multi-site aggregation 164, and corpus storage 166. Multi-worker aggregation 162 aggregates training vectors across multiple workers performing various tasks. Multi-site aggregation 164 aggregates training vectors across multiple sites and environments, including construction sites, manufacturing facilities, healthcare settings, and other work sites. Corpus storage 166 stores the aggregated training corpus for subsequent use in model training and analysis.

The aggregated training corpus 160 provides input to the machine-learning/autonomous-system training layer 180. The machine-learning/autonomous-system training layer 180 includes model training 182, autonomous control training 184, and inference/policy output 186. Model training 182 trains machine-learning models using the aggregated corpus, where the machine-learning models are computational models trained on the aggregated training corpus to classify, predict, sequence, recommend, or control physical task execution or related operational behavior. Autonomous control training 184 trains autonomous control systems using the training data, where the autonomous control systems are robotic, automated, or other machine-executed control systems configured to use trained model outputs to govern physical actions, task execution, or operational decision-making. Inference/policy output 186 generates the trained model outputs and control policies for downstream use in physical task execution or operational decision-making. The machine-learning/autonomous-system training layer 180 trains machine-learning models and autonomous control systems using the instruction-action-corroboration relationships preserved in the training vectors.

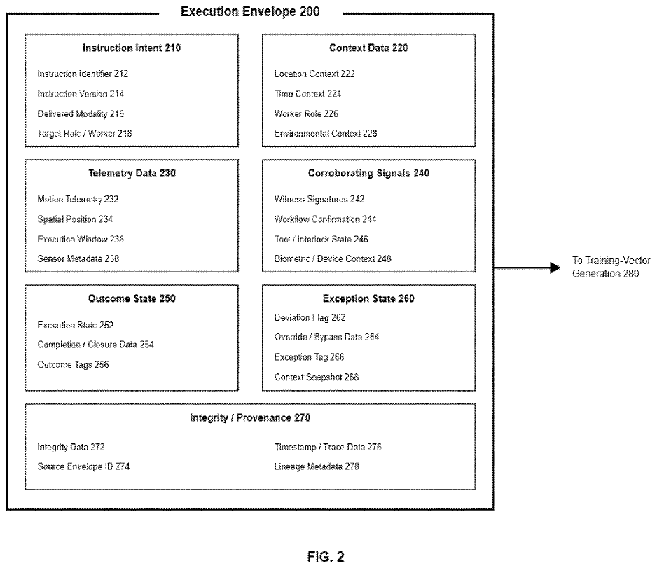

Referring to FIG. 2, an execution envelope 200 serves as a source data primitive for training-vector generation 280. The execution envelope 200 is a bounded execution-context record that captures multiple categories of data associated with a discrete work event. The execution envelope 200 contains instruction intent, context data, telemetry data, corroborating signals, outcome state, exception state, and integrity/provenance information in a unified record structure.

The execution envelope 200 includes an instruction intent 210 section that establishes what a worker was being asked to do and how the instruction was delivered. The instruction intent 210 contains an instruction identifier 212 that uniquely identifies the delivered instruction. The instruction intent 210 further contains an instruction version 214 that identifies the version of the instruction delivered to the worker. A delivered modality 216 within the instruction intent 210 indicates the manner in which the instruction was communicated to the worker, such as through a mobile device, wearable display, audio prompt, or other delivery mechanism. A target role/worker 218 identifies the intended recipient of the instruction, including the worker role or specific worker to whom the instruction was directed.

With continued reference to FIG. 2, the execution envelope 200 includes context data 220 that captures situational information surrounding the execution event. The context data 220 contains a location context 222 that identifies the physical location associated with the work event, such as a construction site zone, manufacturing station, hospital room, or other defined area. A time context 224 within the context data 220 captures temporal information associated with the execution event, including timestamps and time-of-day information. A worker role 226 identifies the role or classification of the worker performing the task. An environmental context 228 captures environmental conditions present during the execution event, such as ambient temperature, lighting conditions, weather conditions, or other environmental factors relevant to the work being performed.

The execution envelope 200 further includes telemetry data 230 that represents sensor and positional information recorded during a bounded execution interval. The telemetry data 230 contains motion telemetry 232 that captures movement data associated with the worker or equipment during task execution. A spatial position 234 within the telemetry data 230 records the physical position of the worker, device, or equipment during the execution window. An execution window 236 defines the time-bounded interval during which telemetry and related execution data are captured for the associated instruction. Sensor metadata 238 contains descriptive information about the sensors used to capture the telemetry data, including sensor type, calibration information, and data quality indicators.

As further shown in FIG. 2, the execution envelope 200 includes corroborating signals 240 that provide supporting evidence increasing confidence in the recorded context or action. The corroborating signals 240 contain witness signatures 242 that represent attestations or confirmations from other workers, supervisors, or observers present during the execution event. A workflow confirmation 244 indicates confirmation signals from workflow systems or process management systems that corroborate task execution. A tool/interlock state 246 captures the state of tools, equipment, or safety interlocks associated with the work event, providing evidence of proper tool usage or safety compliance. A biometric/device context 248 contains biometric data or device-specific context information that supports identification or verification of the worker or device involved in the execution event.

The execution envelope 200 contains an outcome state 250 section that captures the result of the work event. The outcome state 250 includes an execution state 252 that indicates the current or final state of task execution, such as in-progress, completed, or incomplete. Completion/closure data 254 contains information associated with task completion or envelope closure, including completion timestamps and closure conditions. Outcome tags 256 are labels or classifications applied to the outcome of the work event, enabling categorization of execution results for downstream processing and training purposes.

With continued reference to FIG. 2, the execution envelope 200 includes an exception state 260 section that records information when a worker deviates from the delivered instruction. The exception state 260 contains a deviation flag 262 that indicates whether a deviation from the delivered instruction occurred during the execution window. Override/bypass data 264 captures information about override events or bypass events when a worker overrides a procedural step or bypasses a safety interlock. An exception tag 266 is a label identifying the event as an exception-type training example, enabling the record to be used for adaptive or exception-handling model training. A context snapshot 268 captures the contextual conditions present at the moment of deviation, preserving environmental, spatial, and procedural information associated with the exception event.

The execution envelope 200 also includes an integrity/provenance 270 section that provides traceability and validation information for the record. The integrity/provenance 270 contains integrity data 272 that enables verification that the record has not been altered, corrupted, or improperly modified after creation, including hashes, signatures, or other tamper-evident data. A source envelope ID 274 uniquely identifies the execution envelope 200 and enables association of derived training vectors back to the source record. Timestamp/trace data 276 contains temporal and trace information that supports audit and traceability functions. Lineage metadata 278 identifies the source, origin, and derivation history of the record, including relationships to other records or data sources.

The execution envelope 200 connects to training-vector generation 280, indicating that the data contained within the execution envelope 200 serves as input for generating machine-learning training vectors. The structured organization of the execution envelope 200 preserves the relationship between instruction intent, execution-window telemetry, corroborating signals, outcome state, exception state, and integrity/provenance information in a form suitable for transformation into labeled training vectors for machine-learning applications or autonomous control system training.

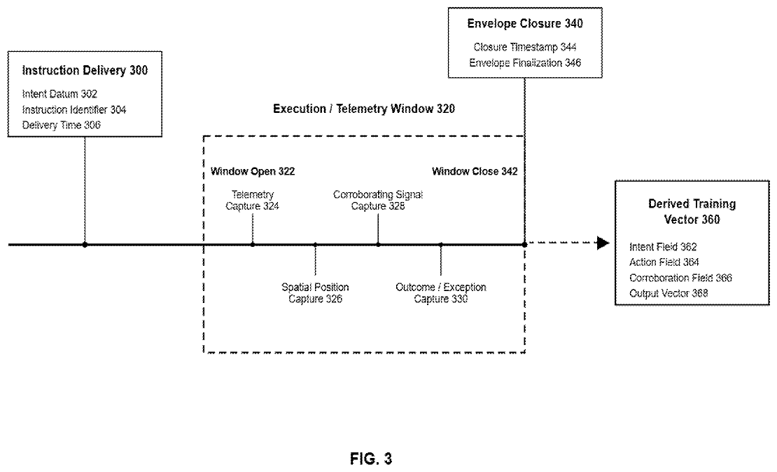

Referring to FIG. 3, an execution-window timeline associated with a delivered instruction illustrates the temporal relationship between instruction delivery, data capture during the execution window, envelope closure, and training-vector derivation. The execution-window timeline depicts how data captured during a bounded execution interval is transformed into a structured training vector that preserves the relationship between the delivered instruction and the captured execution data.

An instruction delivery 300 initiates the execution-window timeline. The instruction delivery 300 contains an intent datum 302 that represents the instruction delivered to a worker, including information sufficient to establish what the worker is being asked to do. The instruction delivery 300 further contains an instruction identifier 304 that uniquely identifies the delivered instruction, enabling association of captured execution data back to the source instruction. A delivery time 306 within the instruction delivery 300 records the timestamp at which the instruction is communicated to the worker, establishing the temporal anchor for the subsequent execution window.

With continued reference to FIG. 3, an execution/telemetry window 320 defines the time-bounded interval during which telemetry and related execution data are captured for the associated instruction. The execution/telemetry window 320 is bounded by a window open 322 at the start of the interval and a window close 342 at the end of the interval. The window open 322 establishes the beginning of the data capture period, which occurs following the instruction delivery 300. The window close 342 marks the termination of the data capture period, after which no additional telemetry or execution data is associated with the current execution envelope.

Within the execution/telemetry window 320, multiple categories of data are captured. A telemetry capture 324 records sensor data and motion information associated with the worker or equipment during task execution. A spatial position capture 326 records the physical position of the worker, device, or equipment during the execution window, providing location-based context for the captured execution data. A corroborating signal capture 328 collects signals that support confidence in the recorded context or action, including witness signatures, workflow confirmations, tool/interlock state, biometric state, or other supporting data. An outcome/exception capture 330 records the result of the work event, including completion state and any deviation information that occurs during the execution window.

As further shown in FIG. 3, an envelope closure 340 occurs at the termination of the execution/telemetry window 320. The envelope closure 340 includes the window close 342 that marks the end of the data capture interval. A closure timestamp 344 records the precise time at which the execution window terminates and the envelope is closed. An envelope finalization 346 completes the execution envelope by sealing the captured data and preparing the record for downstream processing and training-vector generation.

A derived training vector 360 is generated from the data captured during the execution/telemetry window 320. The derived training vector 360 contains an intent field 362 that preserves the instruction intent from the instruction delivery 300, including the intent datum 302 and instruction identifier 304. An action field 364 within the derived training vector 360 contains the telemetry and spatial position data captured during the execution window, representing the physical actions performed by the worker. A corroboration field 366 contains the corroborating signals captured during the execution window, providing supporting evidence for the recorded execution data. An output vector 368 represents the complete, structured training vector ready for use in machine-learning applications or autonomous control system training.

The following example illustrates how the execution-window timeline operates during a typical task execution sequence. A worker at a construction site receives a framing instruction through a mobile device. The instruction delivery 300 records the intent datum 302 identifying the framing task, the instruction identifier 304 uniquely identifying the specific instruction, and the delivery time 306 marking when the instruction is communicated. The window open 322 initiates the execution/telemetry window 320 following instruction delivery. During the execution/telemetry window 320, the telemetry capture 324 records motion data from sensors worn by the worker or attached to tools, the spatial position capture 326 records the worker's location within the construction site zone, the corroborating signal capture 328 collects a witness signature from a supervisor and records tool interlock state from a power tool, and the outcome/exception capture 330 records task completion status. Upon task completion, the window close 342 terminates the execution/telemetry window 320, the closure timestamp 344 records the termination time, and the envelope finalization 346 seals the execution envelope. The derived training vector 360 is then generated, containing the intent field 362 with the framing instruction data, the action field 364 with the captured motion and spatial telemetry, the corroboration field 366 with the witness signature and tool state data, and the output vector 368 representing the complete labeled training record linking instruction intent to physical action and associated verification data.

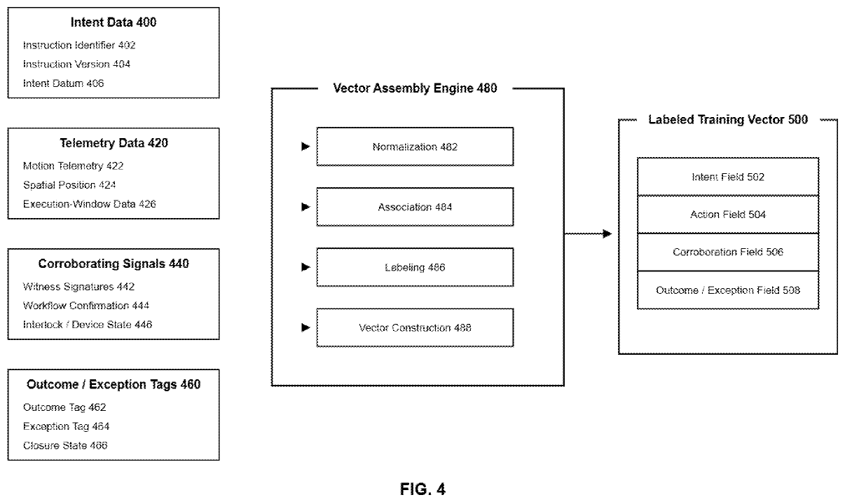

Referring to FIG. 4, a system for transforming intent, telemetry, and corroborating signals into a labeled training vector 500 receives multiple categories of input data and processes the input data through a vector assembly engine 480. The system generates the labeled training vector 500 that preserves the relationship between instruction intent, captured telemetry, corroborating signals, and outcome information in a structured format suitable for machine-learning applications or autonomous control system training.

The system includes intent data 400 that represents information about an instruction delivered to a worker. The intent data 400 contains an instruction identifier 402 that uniquely identifies the delivered instruction, enabling association of captured execution data back to the source instruction. The intent data 400 further contains an instruction version 404 that identifies the version of the instruction delivered to the worker, supporting version tracking and enabling differentiation between instruction revisions. An intent datum 406 within the intent data 400 represents the instruction content delivered to the worker, including information sufficient to establish what action was requested.

With continued reference to FIG. 4, telemetry data 420 is provided as an input to the system. The telemetry data 420 captures physical activity and positional information during the bounded time interval associated with task execution. The telemetry data 420 includes motion telemetry 422 that captures movement data associated with the worker or equipment during task execution, including acceleration, velocity, orientation, or other motion-related measurements. A spatial position 424 within the telemetry data 420 records the physical position of the worker, device, or equipment during the execution window, providing location-based context for the captured execution data. Execution-window data 426 contains temporal information defining the bounded interval during which the telemetry data 420 is captured, including window start time, window end time, and duration information.

Corroborating signals 440 serve as another input category to the system. The corroborating signals 440 provide supporting evidence that increases confidence in the recorded execution context and actions. The corroborating signals 440 include witness signatures 442 that represent attestations or confirmations from other workers, supervisors, or observers present during the execution event. A workflow confirmation 444 indicates confirmation signals from workflow systems or process management systems that corroborate task execution. An interlock/device state 446 captures the state of tools, equipment, or safety interlocks associated with the work event, providing evidence of proper tool usage, safety compliance, or device engagement during task execution.

As further shown in FIG. 4, outcome/exception tags 460 represent a further input to the system. The outcome/exception tags 460 capture the result of the execution event, including whether the task was completed normally or involved a deviation. The outcome/exception tags 460 include an outcome tag 462 that is a label or classification applied to the outcome of the work event, enabling categorization of execution results for downstream processing and training purposes. An exception tag 464 is a label identifying the event as an exception-type training example when a worker deviates from the delivered instruction. A closure state 466 indicates the completion status of the execution envelope, including whether the envelope is open, closed, or finalized.

The vector assembly engine 480 receives the intent data 400, telemetry data 420, corroborating signals 440, and outcome/exception tags 460 as inputs. The vector assembly engine 480 performs several processing operations to transform the input data into a structured training vector. Normalization 482 standardizes the incoming data formats, converting data from different sources and sensors into consistent representations suitable for machine-learning applications. Association 484 links related data elements together, establishing relationships between the instruction intent, captured telemetry, corroborating signals, and outcome information. Labeling 486 applies appropriate labels to the data, including outcome labels, exception labels, and classification labels that enable supervised learning applications. Vector construction 488 assembles the processed data into a structured format, organizing the normalized, associated, and labeled data elements into a unified record structure.

With continued reference to FIG. 4, the output of the vector assembly engine 480 is the labeled training vector 500. The labeled training vector 500 is a structured, machine-learning-ready record that preserves the relationship between instruction intent, captured telemetry, corroborating signals, and outcome information. The labeled training vector 500 includes an intent field 502 that contains the instruction intent information derived from the intent data 400, including the instruction identifier 402, instruction version 404, and intent datum 406. An action field 504 within the labeled training vector 500 contains the telemetry and spatial position data captured during the execution window, representing the physical actions performed by the worker. A corroboration field 506 contains the corroborating signals captured during the execution window, including witness signatures 442, workflow confirmation 444, and interlock/device state 446. An outcome/exception field 508 contains the outcome and exception information derived from the outcome/exception tags 460, including the outcome tag 462, exception tag 464, and closure state 466.

The labeled training vector 500 links instruction intent to physical action and associated verification data in a unified record structure. The labeled training vector 500 is suitable for use in training machine-learning models to classify, predict, sequence, recommend, or control physical task execution. The labeled training vector 500 is also suitable for use in training autonomous control systems to govern physical actions, task execution, or operational decision-making based on the instruction-action-corroboration relationships preserved in the vector structure.

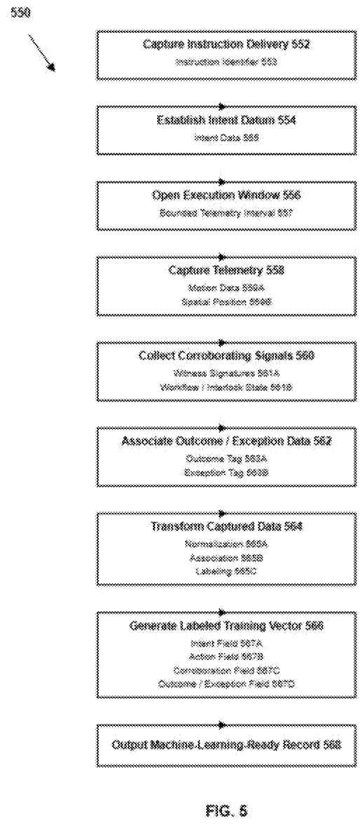

Referring to FIG. 5, a method 550 for generating a machine-learning-ready training vector from execution-envelope-derived data transforms platform-generated execution data into a structured training vector that links instruction intent to physical action and associated verification data. The method 550 includes multiple steps that capture, process, and assemble execution-envelope data into a labeled training vector suitable for machine-learning applications or autonomous control system training.

The method 550 begins with a step 552 for capturing instruction delivery. The step 552 records the delivery of an instruction to a worker and establishes the foundation for the subsequent training vector. The step 552 includes capturing an instruction identifier 553 that uniquely identifies the delivered instruction. The instruction identifier 553 enables association of captured execution data back to the source instruction throughout the training-vector generation process.

With continued reference to FIG. 5, the method 550 proceeds to a step 554 for establishing an intent datum. The step 554 involves establishing intent data 555 that represents the instruction content delivered to the worker. The intent data 555 includes information sufficient to establish what action was requested of the worker. The intent data 555 forms the intent component of the resulting training vector, preserving the relationship between the delivered instruction and the captured execution data.

The method 550 continues to a step 556 for opening an execution window. The step 556 defines a bounded telemetry interval 557 during which telemetry and related execution data are captured for the associated instruction. The bounded telemetry interval 557 establishes the temporal boundaries for data capture, ensuring that telemetry, corroborating signals, and outcome information are associated with the correct instruction delivery event. The bounded telemetry interval 557 begins following instruction delivery and terminates upon task completion or envelope closure.

As further shown in FIG. 5, the method 550 advances to a step 558 for capturing telemetry during the bounded telemetry interval 557. The step 558 includes capturing motion data 559a that records movement information associated with the worker or equipment during task execution. The motion data 559a includes acceleration, velocity, orientation, or other motion-related measurements captured by sensors worn by the worker or attached to tools and equipment. The step 558 further includes capturing spatial position 559b that records the physical position of the worker, device, or equipment during the execution window. The spatial position 559b provides location-based context for the captured execution data.

The method 550 proceeds to a step 560 for collecting corroborating signals during the bounded telemetry interval 557. The step 560 includes collecting witness signatures 561a that represent attestations or confirmations from other workers, supervisors, or observers present during the execution event. The witness signatures 561a provide supporting evidence that increases confidence in the recorded execution context and actions. The step 560 further includes collecting workflow/interlock state 561b that captures the state of workflow systems, tools, equipment, or safety interlocks associated with the work event. The workflow/interlock state 561b provides evidence of proper tool usage, safety compliance, or workflow progression during task execution.

With continued reference to FIG. 5, the method 550 continues to a step 562 for associating outcome or exception data with the captured execution data. The step 562 includes associating an outcome tag 563a that is a label or classification applied to the outcome of the work event. The outcome tag 563a enables categorization of execution results for downstream processing and training purposes. The step 562 further includes associating an exception tag 563b when a worker deviates from the delivered instruction. The exception tag 563b identifies the event as an exception-type training example, enabling the record to be used for adaptive or exception-handling model training.

The method 550 advances to a step 564 for transforming the captured data into a format suitable for machine-learning applications. The step 564 includes normalization 565a that standardizes the incoming data formats, converting data from different sources and sensors into consistent representations. The step 564 further includes association 565b that links related data elements together, establishing relationships between the instruction intent, captured telemetry, corroborating signals, and outcome information. The step 564 also includes labeling 565c that applies appropriate labels to the data, including outcome labels, exception labels, and classification labels that enable supervised learning applications.

As further shown in FIG. 5, the method 550 proceeds to a step 566 for generating a labeled training vector from the transformed data. The step 566 produces a labeled training vector that includes an intent field 567a containing the instruction intent information derived from the intent data 555 and instruction identifier 553. The labeled training vector further includes an action field 567b containing the telemetry and spatial position data captured during the execution window, representing the physical actions performed by the worker. The labeled training vector includes a corroboration field 567c containing the corroborating signals captured during the execution window, including the witness signatures 561a and workflow/interlock state 561b. The labeled training vector also includes an outcome/exception field 567d containing the outcome and exception information, including the outcome tag 563a and exception tag 563b.

The method 550 concludes with a step 568 for outputting a machine-learning-ready record. The step 568 outputs the labeled training vector as a structured, machine-learning-ready record that preserves the relationship between instruction intent, captured telemetry, corroborating signals, and outcome information. The output record is suitable for use in training machine-learning models to classify, predict, sequence, recommend, or control physical task execution. The output record is also suitable for use in training autonomous control systems to govern physical actions, task execution, or operational decision-making.

The following construction example illustrates the method 550 during a typical task execution sequence. A worker at a construction site receives a framing instruction through a mobile device. At step 552, the system captures the instruction delivery and records the instruction identifier 553 uniquely identifying the framing instruction. At step 554, the system establishes the intent data 555 representing the framing task content. At step 556, the system opens the execution window and defines the bounded telemetry interval 557 for data capture. During the bounded telemetry interval 557, at step 558, the system captures motion data 559a from sensors worn by the worker and spatial position 559b indicating the worker's location within the construction site zone. At step 560, the system collects witness signatures 561a from a supervisor present during the framing task and workflow/interlock state 561b from a power tool engaged during task execution. At step 562, the system associates an outcome tag 563a indicating task completion status. At step 564, the system performs normalization 565a to standardize the captured data formats, association 565b to link the telemetry and corroborating signals to the instruction intent, and labeling 565c to apply appropriate classification labels. At step 566, the system generates the labeled training vector containing the intent field 567a with the framing instruction data, the action field 567b with the captured motion and spatial telemetry, the corroboration field 567c with the witness signature and tool state data, and the outcome/exception field 567d with the completion status. At step 568, the system outputs the machine-learning-ready record linking the framing instruction intent to the physical actions performed by the worker and the associated verification data.

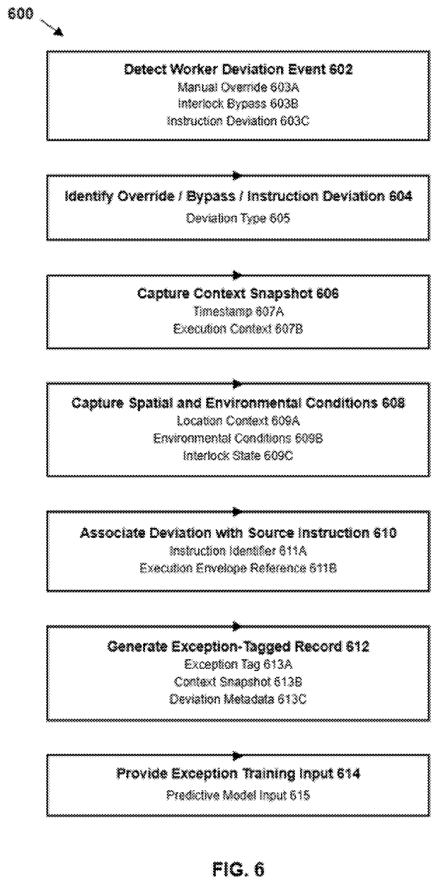

Referring to FIG. 6, a method 600 for generating exception-tagged deviation training records transforms worker deviation events into structured training records that capture contextual information surrounding the deviation. The method 600 enables the use of worker deviations, overrides, or bypasses as training examples for predictive models, allowing systems to learn how experienced humans adapt to changing real-world conditions.

The method 600 begins with a step 602 for detecting a worker deviation event. The step 602 encompasses detection of several types of deviation events. A manual override 603a represents an event where a worker manually overrides a procedural step or system recommendation. An interlock bypass 603b represents an event where a worker bypasses a safety interlock or protective mechanism. An instruction deviation 603c represents an event where a worker deviates from the delivered instruction in a manner other than a direct override or bypass. The step 602 monitors execution-envelope data to identify when a worker departs from the prescribed procedure or delivered instruction.

With continued reference to FIG. 6, the method 600 proceeds to a step 604 for identifying the override, bypass, or instruction deviation. The step 604 involves determining a deviation type 605 associated with the detected event. The deviation type 605 categorizes the nature of the deviation, distinguishing between manual overrides, interlock bypasses, and instruction deviations. The deviation type 605 enables downstream processing and model training to differentiate between different forms of worker departure from prescribed procedures.

The method 600 continues to a step 606 for capturing a context snapshot at the moment of deviation. The step 606 includes capturing a timestamp 607a that records the precise time at which the deviation event occurred. The step 606 further includes capturing an execution context 607b that records the procedural state and execution conditions present at the moment of deviation. The timestamp 607a and execution context 607b together establish the temporal and procedural circumstances surrounding the deviation event.

As further shown in FIG. 6, the method 600 advances to a step 608 for capturing spatial and environmental conditions present at the time of the deviation. The step 608 includes capturing a location context 609a that identifies the physical location associated with the deviation event, such as a construction site zone, manufacturing station, hospital room, or other defined area. The step 608 further includes capturing environmental conditions 609b that record ambient conditions present during the deviation, such as temperature, lighting, weather, or other environmental factors. The step 608 also includes capturing an interlock state 609c that records the state of safety interlocks, equipment, or protective mechanisms at the moment of deviation.

The method 600 proceeds to a step 610 for associating the deviation with a source instruction. The step 610 includes linking the deviation to an instruction identifier 611a that uniquely identifies the delivered instruction from which the worker deviated. The step 610 further includes linking the deviation to an execution envelope reference 611b that associates the deviation record back to the source execution envelope containing the original instruction delivery, telemetry, and context data. The instruction identifier 611a and execution envelope reference 611b preserve the relationship between the deviation event and the delivered guidance.

With continued reference to FIG. 6, the method 600 continues to a step 612 for generating an exception-tagged record. The step 612 involves creating a structured record that includes an exception tag 613a identifying the event as an exception-type training example. The step 612 further includes a context snapshot 613b containing the captured contextual conditions from steps 606 and 608. The step 612 also includes deviation metadata 613c containing additional information about the deviation event, including the deviation type 605, the instruction identifier 611a, and the execution envelope reference 611b. The exception-tagged record preserves the contextual information surrounding the deviation in a structured format suitable for machine-learning applications.

The method 600 concludes with a step 614 for providing exception training input. The step 614 outputs a predictive model input 615 that serves as a training example for machine-learning models or autonomous control systems. The predictive model input 615 enables systems to learn from real-world worker adaptations to changing conditions, treating deviations as adaptive training examples rather than failures. The predictive model input 615 feeds into the labeled training vectors 150 and subsequently into the aggregated training corpus 160 for use in model training 182 or autonomous control training 184.

The following hospital example illustrates the method 600 during a deviation handling sequence. A caregiver at a healthcare facility receives a medication administration instruction through a mobile device specifying a particular medication window and room assignment. At step 602, the system detects a worker deviation event when the caregiver bypasses the prescribed medication timing due to an observed change in patient condition. At step 604, the system identifies the deviation as an instruction deviation 603c and determines the deviation type 605 as a timing-related departure from the delivered guidance. At step 606, the system captures the timestamp 607a recording when the deviation occurred and the execution context 607b indicating the caregiver was in the medication administration workflow. At step 608, the system captures the location context 609a identifying the patient room or beacon-defined zone, the environmental conditions 609b including relevant ambient factors, and the interlock state 609c indicating the state of medication dispensing systems or access controls. At step 610, the system associates the deviation with the source instruction via the instruction identifier 611a identifying the medication administration instruction and the execution envelope reference 611b linking back to the original execution envelope. At step 612, the system generates the exception-tagged record containing the exception tag 613a, the context snapshot 613b with the captured spatial and environmental data, and the deviation metadata 613c describing the timing deviation and associated circumstances. At step 614, the system provides the predictive model input 615 as an adaptive training example, enabling machine-learning models to learn how experienced caregivers adapt medication timing based on patient condition observations and safety judgments.

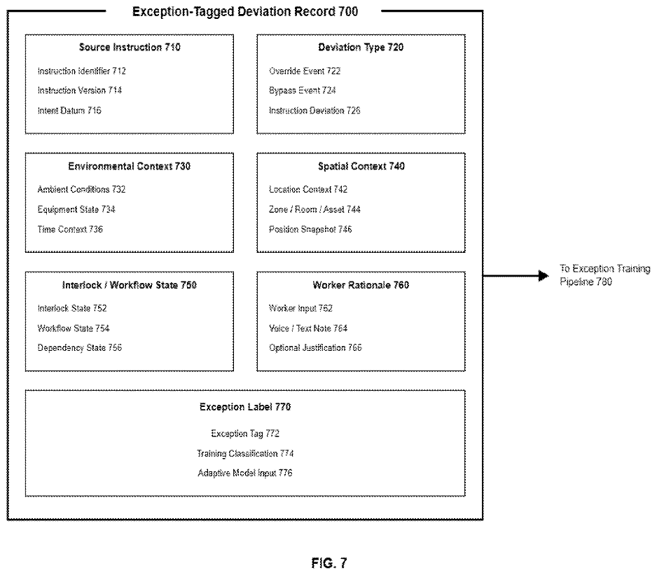

Referring to FIG. 7, an exception-tagged deviation record 700 represents a structured data record generated from a worker deviation or override event. The exception-tagged deviation record 700 captures contextual information when a worker deviates from a delivered instruction, and the exception-tagged deviation record 700 is provided to an exception training pipeline 780 for use in adaptive model training. The exception-tagged deviation record 700 preserves the relationship between the deviation event and the delivered guidance in a format suitable for machine-learning applications.

The exception-tagged deviation record 700 includes a source instruction 710 section that establishes the original instruction from which the worker deviated. The source instruction 710 contains an instruction identifier 712 that uniquely identifies the delivered instruction associated with the deviation event. The source instruction 710 further contains an instruction version 714 that identifies the version of the instruction delivered to the worker, supporting version tracking and enabling differentiation between instruction revisions. An intent datum 716 within the source instruction 710 represents the instruction content delivered to the worker, including information sufficient to establish what action was requested prior to the deviation.

With continued reference to FIG. 7, the exception-tagged deviation record 700 includes a deviation type 720 section that categorizes the nature of the deviation. The deviation type 720 distinguishes between different forms of worker departure from prescribed procedures. An override event 722 within the deviation type 720 represents an event where a worker manually overrides a procedural step or system recommendation. A bypass event 724 represents an event where a worker bypasses a safety interlock or protective mechanism. An instruction deviation 726 represents an event where a worker departs from the delivered instruction in a manner other than a direct override or bypass. The deviation type 720 enables downstream processing and model training to differentiate between different categories of worker adaptation.

The exception-tagged deviation record 700 further includes an environmental context 730 section that captures environmental circumstances present at the time of the deviation event. The environmental context 730 contains ambient conditions 732 that record environmental factors such as temperature, lighting conditions, weather conditions, or other ambient factors relevant to the deviation. An equipment state 734 within the environmental context 730 captures the operational state of equipment, tools, or machinery present during the deviation event. A time context 736 records temporal information associated with the deviation, including timestamps, time-of-day information, and duration data relevant to the deviation circumstances.

As further shown in FIG. 7, the exception-tagged deviation record 700 includes a spatial context 740 section that records the physical location and spatial positioning associated with the deviation. The spatial context 740 contains a location context 742 that identifies the physical location associated with the deviation event, such as a construction site zone, manufacturing station, hospital room, or other defined area. A zone/room/asset 744 within the spatial context 740 provides more granular location information identifying the specific zone, room, or asset associated with the deviation. A position snapshot 746 captures the precise spatial position of the worker, device, or equipment at the moment of deviation, preserving location-based context for the exception record.

The exception-tagged deviation record 700 contains an interlock/workflow state 750 section that captures procedural and system states at the moment of deviation. The interlock/workflow state 750 includes an interlock state 752 that records the state of safety interlocks, protective mechanisms, or access controls at the time of the deviation event. A workflow state 754 within the interlock/workflow state 750 captures the current state of workflow systems or process management systems, indicating where in the prescribed procedure the deviation occurred. A dependency state 756 records the state of task dependencies, prerequisite conditions, or sequential requirements associated with the work event at the moment of deviation.

With continued reference to FIG. 7, the exception-tagged deviation record 700 includes a worker rationale 760 section that allows capture of the worker's reasoning or explanation for the deviation event. The worker rationale 760 contains a worker input 762 that captures direct input from the worker regarding the deviation, including selections from predefined options or structured responses. A voice/text note 764 within the worker rationale 760 captures audio recordings or text entries provided by the worker explaining the circumstances or reasoning behind the deviation. An optional justification 766 provides a field for additional worker-provided explanation or justification for the departure from the delivered instruction.

The exception-tagged deviation record 700 also includes an exception label 770 section that provides labeling and classification information enabling the record to function as a training example. The exception label 770 contains an exception tag 772 that is a label identifying the event as an exception-type training example, distinguishing the record from standard execution records. A training classification 774 within the exception label 770 categorizes the deviation for training purposes, enabling differentiation between different types of adaptive training examples. An adaptive model input 776 indicates that the record is formatted and labeled for use as input to adaptive or exception-handling machine-learning models.

The exception-tagged deviation record 700 is output to the exception training pipeline 780. The exception training pipeline 780 receives the exception-tagged deviation record 700 and processes the record for use in training machine-learning models or autonomous control systems. The exception-tagged deviation record 700 serves as an adaptive training example within the exception training pipeline 780, enabling systems to learn from real-world worker adaptations to changing conditions. The exception training pipeline 780 treats deviations captured in the exception-tagged deviation record 700 as adaptive training examples rather than failures, allowing machine-learning models to learn how experienced workers adapt to environmental changes, safety considerations, or other factors that prompt departure from delivered instructions.

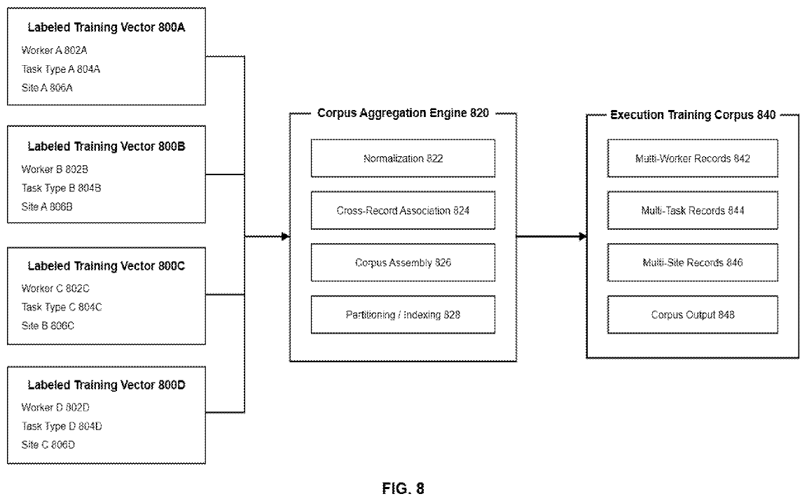

Referring to FIG. 8, a system for aggregating labeled training vectors across multiple workers, tasks, and sites into an Execution Training Corpus 840 receives multiple labeled training vectors as inputs, processes the labeled training vectors through a Corpus Aggregation Engine 820, and outputs a unified Execution Training Corpus 840. The system enables the transformation of individual execution-envelope-derived training vectors into a comprehensive, organized training corpus that preserves instruction-action-corroboration relationships while supporting aggregation across diverse workers, tasks, and operational environments.

The input side of the system includes multiple labeled training vectors generated from execution-envelope-derived data. The Labeled Training Vector 800a represents execution-envelope-derived data from a first worker performing a first task type at a first site. A Labeled Training Vector 800b contains Worker B 802b, Task Type B 804b, and Site A 806b. The Labeled Training Vector 800b represents execution-envelope-derived data from a second worker performing a second task type at the first site. A Labeled Training Vector 800c contains Worker C 802c, Task Type C 804c, and Site B 806c. The Labeled Training Vector 800c represents execution-envelope-derived data from a third worker performing a third task type at a second site. A Labeled Training Vector 800d contains Worker D 802d, Task Type D 804d, and Site C 806d. The Labeled Training Vector 800d represents execution-envelope-derived data from a fourth worker performing a fourth task type at a third site.

With continued reference to FIG. 8, the Corpus Aggregation Engine 820 receives the Labeled Training Vector 800a, the Labeled Training Vector 800b, the Labeled Training Vector 800c, and the Labeled Training Vector 800d as inputs. The Corpus Aggregation Engine 820 performs several processing operations to combine the labeled training vectors into a unified corpus structure. Normalization 822 standardizes the data formats and structures across the incoming vectors, converting data from different workers, task types, and sites into consistent representations suitable for aggregated machine-learning applications. The Normalization 822 ensures that training vectors from different sources conform to a common schema and data format.

Cross-Record Association 824 within the Corpus Aggregation Engine 820 establishes relationships and linkages between records from different sources. The Cross-Record Association 824 identifies commonalities and relationships across training vectors, such as shared task types, overlapping site characteristics, similar worker roles, or related instruction categories. The Cross-Record Association 824 enables the Execution Training Corpus 840 to support queries and training operations that span multiple workers, tasks, or sites.

As further shown in FIG. 8, Corpus Assembly 826 within the Corpus Aggregation Engine 820 combines the normalized and associated records into a cohesive dataset. The Corpus Assembly 826 merges the individual labeled training vectors into a unified corpus structure while preserving the instruction-action-corroboration relationships contained within each source vector. The Corpus Assembly 826 maintains traceability back to the source execution envelopes from which the training vectors were derived.

Partitioning/Indexing 828 within the Corpus Aggregation Engine 820 organizes the assembled corpus by relevant categories to facilitate efficient retrieval and training operations. The Partitioning/Indexing 828 partitions the corpus by task type, enabling retrieval of training vectors associated with specific categories of work. The Partitioning/Indexing 828 further partitions the corpus by site, enabling retrieval of training vectors associated with specific operational environments such as construction sites, manufacturing facilities, healthcare settings, or other work sites. The Partitioning/Indexing 828 also partitions the corpus by worker role, enabling retrieval of training vectors associated with specific worker classifications or job functions.

With continued reference to FIG. 8, the Execution Training Corpus 840 represents the output of the aggregation process performed by the Corpus Aggregation Engine 820. The Execution Training Corpus 840 contains several categories of organized records aggregated from the input labeled training vectors. Multi-Worker Records 842 within the Execution Training Corpus 840 aggregates training data across multiple workers, including the Worker A 802a, the Worker B 802b, the Worker C 802c, and the Worker D 802d. The Multi-Worker Records 842 enables machine-learning models to learn from execution patterns across different workers performing various tasks.

Multi-Task Records 844 within the Execution Training Corpus 840 aggregates training data across different task types, including the Task Type A 804a, the Task Type B 804b, the Task Type C 804c, and the Task Type D 804d. The Multi-Task Records 844 enables machine-learning models to learn from execution patterns across different categories of work, supporting generalization across task types and identification of task-specific execution characteristics.

As further shown in FIG. 8, Multi-Site Records 846 within the Execution Training Corpus 840 aggregates training data across multiple work sites, including the Site A 806a, the Site A 806b, the Site B 806c, and the Site C 806d. The Multi-Site Records 846 enables machine-learning models to learn from execution patterns across different operational environments, supporting generalization across sites and identification of site-specific execution characteristics. The Multi-Site Records 846 includes training vectors from construction sites, manufacturing facilities, healthcare settings, and other work environments.

Corpus Output 848 within the Execution Training Corpus 840 provides the final aggregated training corpus for downstream use in machine-learning model training or autonomous control system training. The Corpus Output 848 delivers the aggregated, normalized, and indexed training data to the machine-learning/autonomous-system training layer 180 for use in model training 182 and autonomous control training 184. The Corpus Output 848 preserves the instruction-action-corroboration relationships from the source labeled training vectors while providing organized access to training data aggregated across multiple workers, tasks, and sites.

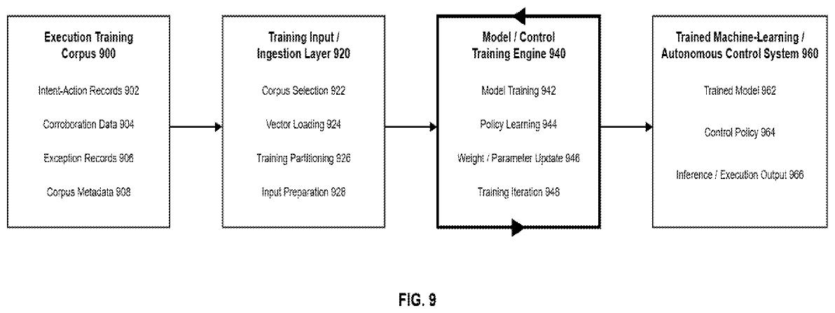

Referring to FIG. 9, a system for training a machine-learning model or autonomous control system using an aggregated execution training corpus includes an execution training corpus 900, a training input/ingestion layer 920, a model/control training engine 940, and a trained machine-learning/autonomous control system 960. The system ingests the aggregated training vectors and uses the instruction-action-corroboration relationships preserved in the vectors to train decision models, robotics models, or control policies for physical task execution and operational decision-making.

The execution training corpus 900 serves as the source data for the training pipeline. The execution training corpus 900 includes intent-action records 902 that contain structured data linking instruction intent to captured telemetry and associated outcome information. The intent-action records 902 preserve the relationship between the instruction that was delivered to a worker, the execution window during which the worker acted, and the telemetry captured during that window. The execution training corpus 900 further includes corroboration data 904 that contains signals supporting confidence in the recorded context or action, including witness signatures, workflow confirmations, tool/interlock state, biometric state, and outcome tags aggregated from the source labeled training vectors.

With continued reference to FIG. 9, the execution training corpus 900 includes exception records 906 that contain exception-tagged deviation records generated when workers override, bypass, or deviate from delivered instructions. The exception records 906 capture contextual information surrounding deviation events, enabling machine-learning models to learn how experienced workers adapt to changing real-world conditions. The execution training corpus 900 also includes corpus metadata 908 that provides descriptive information about the corpus structure, contents, and organization, including partitioning information, indexing data, and source envelope references.

The training input/ingestion layer 920 receives data from the execution training corpus 900 and prepares the data for model training. The training input/ingestion layer 920 includes corpus selection 922 that selects appropriate training data from the execution training corpus 900 based on training objectives, task types, site characteristics, or other selection criteria. Vector loading 924 within the training input/ingestion layer 920 loads the selected training vectors into the system for processing, retrieving the intent-action records 902, corroboration data 904, and exception records 906 from the corpus storage.

As further shown in FIG. 9, training partitioning 926 within the training input/ingestion layer 920 divides the loaded data into appropriate training sets, including training sets, validation sets, and test sets for model development and evaluation. The training partitioning 926 partitions data by task type, site, worker role, or outcome category to support targeted training objectives. Input preparation 928 within the training input/ingestion layer 920 formats the partitioned data for ingestion by the model/control training engine 940, converting the training vectors into the input format required by the specific machine-learning algorithms or control system training processes.

The model/control training engine 940 receives prepared data from the training input/ingestion layer 920 and performs training operations. The model/control training engine 940 includes model training 942 that trains machine-learning models using the aggregated corpus. The model training 942 uses the instruction-action-corroboration relationships preserved in the training vectors to train computational models that classify, predict, sequence, recommend, or control physical task execution. The model training 942 processes the intent-action records 902 to learn relationships between delivered instructions and resulting worker actions, and processes the exception records 906 to learn adaptive behaviors from real-world worker deviations.

With continued reference to FIG. 9, policy learning 944 within the model/control training engine 940 learns control policies from the training data. The policy learning 944 derives control policies that govern physical actions, task execution, or operational decision-making based on the patterns captured in the execution training corpus 900. The policy learning 944 uses the corroboration data 904 to weight training examples based on the level of supporting evidence associated with each record.

Weight/parameter update 946 within the model/control training engine 940 updates model weights and parameters during training. The weight/parameter update 946 adjusts the internal parameters of the machine-learning models or control policies based on the training data, optimizing the models to accurately represent the instruction-action-corroboration relationships in the corpus. Training iteration 948 within the model/control training engine 940 iterates through training cycles, repeatedly processing the training data to refine model performance. A feedback loop connects the model/control training engine 940 back to the training input/ingestion layer 920 to support iterative training processes and enable refinement based on validation results.

As further shown in FIG. 9, the trained machine-learning/autonomous control system 960 represents the output of the training process. The trained machine-learning/autonomous control system 960 includes a trained model 962 that is a computational model trained on the aggregated training corpus to classify, predict, sequence, recommend, or control physical task execution or related operational behavior. The trained model 962 incorporates the instruction-action-corroboration relationships learned from the execution training corpus 900.

The trained machine-learning/autonomous control system 960 further includes a control policy 964 that governs physical actions, task execution, or operational decision-making. The control policy 964 is derived from the policy learning 944 process and encodes the learned relationships between instruction intent, execution context, and appropriate actions. The trained machine-learning/autonomous control system 960 also includes inference/execution output 966 that provides the operational outputs generated by the trained system during deployment. The inference/execution output 966 delivers predictions, classifications, recommendations, or control signals based on the trained model 962 and control policy 964.

The following construction example illustrates training of a decision model using the execution training corpus 900. A construction company aggregates labeled training vectors from framing, electrical, and plumbing tasks performed across multiple construction sites. The training input/ingestion layer 920 selects vectors associated with framing tasks via corpus selection 922, loads the vectors via vector loading 924, partitions the data into training and validation sets via training partitioning 926, and prepares the input via input preparation 928. The model/control training engine 940 trains a task-sequencing model via model training 942 that learns the relationship between framing instruction intent and the motion telemetry patterns associated with successful task completion. The trained model 962 outputs task-sequencing recommendations for framing operations based on the learned instruction-action relationships.

The following robotics example illustrates training of an autonomous control system using the execution training corpus 900. A manufacturing facility aggregates labeled training vectors from assembly tasks performed by workers across multiple production lines. The exception records 906 include deviation records capturing instances where workers adapted assembly procedures due to component variations or equipment conditions. The model/control training engine 940 trains a robotic assembly control policy via policy learning 944 that learns both standard assembly sequences from the intent-action records 902 and adaptive behaviors from the exception records 906. The control policy 964 governs robotic arm movements and assembly sequences, incorporating learned adaptations for handling component variations encountered in real-world manufacturing environments.

The following healthcare example illustrates training of a predictive model using the execution training corpus 900. A healthcare network aggregates labeled training vectors from medication administration and patient care tasks performed by caregivers across multiple facilities. The corroboration data 904 includes workflow confirmations and device state information associated with each care event. The model/control training engine 940 trains a care-scheduling model via model training 942 that learns relationships between care instruction intent, spatial context, and successful task completion patterns. The trained model 962 outputs care-scheduling predictions and workflow recommendations based on the instruction-action-corroboration relationships learned from the aggregated corpus.

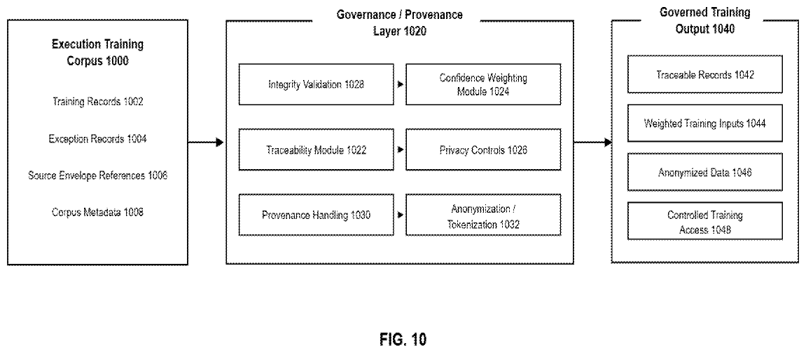

Referring to FIG. 10, a governance/provenance layer 1020 associated with an execution training corpus 1000 provides traceability, confidence weighting, privacy controls, integrity validation, provenance handling, and anonymization functions for training data used in machine-learning model training or autonomous control system training. The governance/provenance layer 1020 processes data from the execution training corpus 1000 and produces a governed training output 1040 that includes traceable records, weighted training inputs, anonymized data, and controlled training access.

The execution training corpus 1000 serves as the input to the governance/provenance layer 1020. The execution training corpus 1000 includes training records 1002 that contain labeled training vectors generated from execution-envelope-derived data. The training records 1002 preserve the relationship between instruction intent, captured telemetry, corroborating signals, and outcome information in structured formats suitable for machine-learning applications. The execution training corpus 1000 further includes exception records 1004 that contain exception-tagged deviation records generated when workers override, bypass, or deviate from delivered instructions. The exception records 1004 capture contextual information surrounding deviation events for use in adaptive or exception-handling model training.

With continued reference to FIG. 10, the execution training corpus 1000 includes source envelope references 1006 that maintain associations back to the original execution envelopes from which the training data was derived. The source envelope references 1006 enable traceability from training vectors and exception records back to the source execution envelopes containing the original instruction delivery, telemetry, context, and outcome data. The execution training corpus 1000 also includes corpus metadata 1008 that contains descriptive information about the training corpus, including partitioning information, indexing data, aggregation parameters, and organizational structure.

The governance/provenance layer 1020 receives data from the execution training corpus 1000 and processes the data through several modules. An integrity validation 1028 within the governance/provenance layer 1020 verifies that records, vectors, or dataset elements have not been altered, corrupted, or improperly modified after creation. The integrity validation 1028 performs verification through cryptographic hashes that detect modifications to record contents. The integrity validation 1028 further performs verification through digital signatures that authenticate the source and integrity of records. The integrity validation 1028 also performs verification through append-only storage logic that prevents modification of previously written records. The integrity validation 1028 connects to a confidence weighting module 1024 within the governance/provenance layer 1020, providing integrity status information that influences confidence scores assigned to training records.

As further shown in FIG. 10, the confidence weighting module 1024 within the governance/provenance layer 1020 assigns relative weights, scores, or levels of confidence to records or training vectors. The confidence weighting module 1024 determines confidence weights based on the quantity of corroborating signals associated with a record, where records with multiple corroborating signals receive higher confidence weights than records with fewer corroborating signals. The confidence weighting module 1024 further determines confidence weights based on the quality of corroborating signals, where records corroborated by witness signatures from supervisors or workflow confirmations from verified systems receive higher confidence weights than records corroborated by less authoritative sources. The confidence weighting module 1024 also determines confidence weights based on the type of corroborating signals, where records including biometric verification, tool interlock state confirmation, and spatial position corroboration receive higher confidence weights than records lacking such multi-modal corroboration. The confidence weighting module 1024 additionally considers telemetry completeness, outcome information, exception information, and integrity validation results when assigning confidence weights to training records.

With continued reference to FIG. 10, a traceability module 1022 within the governance/provenance layer 1020 enables the ability to associate training vectors, exception-tagged deviation records, or corpus elements back to the source execution envelopes from which the training vectors, exception-tagged deviation records, or corpus elements were derived. The traceability module 1022 maintains linkages between derived training records and the source envelope references 1006 contained in the execution training corpus 1000. The traceability module 1022 enables audit functions that trace a training vector back through the transformation pipeline to the original execution envelope containing the instruction delivery, telemetry capture, corroborating signals, and outcome data. The traceability module 1022 connects to privacy controls 1026 within the governance/provenance layer 1020, enabling privacy-aware traceability that respects data access restrictions while maintaining provenance information.

The privacy controls 1026 within the governance/provenance layer 1020 implement rules, filters, permissions, or processing steps that govern what data is collected, retained, transformed, disclosed, or used for training, analysis, or downstream system operation. The privacy controls 1026 enforce data collection policies that specify what categories of worker information, device information, patient information, or site information are captured in training records. The privacy controls 1026 further enforce data retention policies that specify how long training records are stored and when training records are deleted or archived. The privacy controls 1026 also enforce data disclosure policies that specify what training data is shared with external systems, third parties, or downstream applications. The privacy controls 1026 additionally enforce data use policies that specify what training operations, analysis functions, or model training processes are permitted for different categories of training data.

As further shown in FIG. 10, a provenance handling 1030 within the governance/provenance layer 1020 manages metadata identifying the source, origin, lineage, or derivation of training vectors, records, or dataset elements. The provenance handling 1030 maintains provenance metadata that identifies the execution envelope from which a training vector was derived, the transformation pipeline stages through which the data passed, the aggregation operations that combined the record with other records, and the temporal sequence of processing operations. The provenance handling 1030 connects to an anonymization/tokenization 1032 within the governance/provenance layer 1020, enabling provenance-preserving anonymization that maintains lineage information while removing personally identifying information.

The anonymization/tokenization 1032 within the governance/provenance layer 1020 removes, masks, tokenizes, or otherwise reduces personally identifying information associated with workers, devices, patients, or sites while preserving the usefulness of the resulting training data. The anonymization/tokenization 1032 performs worker anonymization by replacing worker identifiers with anonymized tokens that enable record linkage across training vectors without revealing worker identity. The anonymization/tokenization 1032 performs device anonymization by removing or masking device serial numbers, MAC addresses, or other device-specific identifiers from training records. The anonymization/tokenization 1032 performs patient anonymization in healthcare settings by removing patient names, medical record numbers, and other protected health information from training records while preserving clinically relevant execution context. The anonymization/tokenization 1032 performs site anonymization by replacing site identifiers with anonymized location tokens that preserve geographic or environmental characteristics relevant to training without revealing specific site identity. The anonymization/tokenization 1032 applies k-anonymity, differential privacy, or other privacy-preserving techniques to ensure that training records cannot be re-identified through combination with external data sources.

With continued reference to FIG. 10, the governed training output 1040 receives processed data from the governance/provenance layer 1020 and provides training data with governance, provenance, confidence, and privacy protections applied. The governed training output 1040 includes traceable records 1042 that maintain provenance information linking training vectors and exception records back to source execution envelopes. The traceable records 1042 enable downstream systems to verify the origin and derivation of training data used in model training or autonomous control system training.

The governed training output 1040 further includes weighted training inputs 1044 that contain confidence-weighted training data produced by the confidence weighting module 1024. The weighted training inputs 1044 enable machine-learning training processes to weight training examples based on the level of corroboration, integrity validation status, and data quality associated with each record. Training processes use the weighted training inputs 1044 to give greater influence to high-confidence records with strong corroboration and verified integrity, and lesser influence to lower-confidence records with limited corroboration or incomplete data.

As further shown in FIG. 10, the governed training output 1040 includes anonymized data 1046 that contains privacy-protected training information produced by the anonymization/tokenization 1032. The anonymized data 1046 preserves the instruction-action-corroboration relationships from the source training records while removing or masking personally identifying information. The anonymized data 1046 enables training of machine-learning models and autonomous control systems using real-world execution data without exposing worker identity, patient information, or site-specific details.

The governed training output 1040 also includes controlled training access 1048 that provides governed access to the training data for downstream machine-learning or autonomous-system training applications. The controlled training access 1048 enforces access controls that restrict training data access based on user roles, system permissions, or data classification levels. The controlled training access 1048 provides audit logging that records what training data is accessed, by what systems or users, and for what purposes. The controlled training access 1048 delivers the governed training data to the machine-learning/autonomous-system training layer 180 for use in model training 182 and autonomous control training 184.

The following construction example illustrates operation of the governance/provenance layer 1020. A construction company generates training records from framing tasks performed across multiple construction sites. The integrity validation 1028 computes cryptographic hashes for each training record and verifies digital signatures from the source execution envelopes. The confidence weighting module 1024 assigns higher confidence weights to records that include witness signatures from site supervisors, tool interlock confirmations from power tools, and spatial position data corroborated by multiple sensors. The traceability module 1022 maintains linkages from each training vector back to the source execution envelope containing the original framing instruction delivery and captured telemetry. The privacy controls 1026 enforce policies that restrict access to training data containing worker location patterns to authorized safety analysis applications. The anonymization/tokenization 1032 replaces worker identifiers with anonymized tokens and removes site addresses while preserving site type classifications relevant to training. The governed training output 1040 delivers traceable records 1042 with verified provenance, weighted training inputs 1044 with confidence scores based on corroboration levels, anonymized data 1046 with worker and site identifiers removed, and controlled training access 1048 that enforces role-based access restrictions.

The following healthcare example illustrates operation of the governance/provenance layer 1020. A healthcare network generates training records from medication administration tasks performed by caregivers across multiple facilities. The integrity validation 1028 verifies that training records have not been modified since creation using append-only storage validation and cryptographic hash verification. The confidence weighting module 1024 assigns higher confidence weights to records that include workflow confirmations from medication dispensing systems, biometric verification of caregiver identity, and spatial position data confirming presence in the correct patient room. The traceability module 1022 maintains linkages from each training vector back to the source execution envelope while respecting privacy boundaries that limit access to patient-specific provenance information. The privacy controls 1026 enforce policies that require anonymization of patient information before training data is used for model development. The anonymization/tokenization 1032 removes patient names, medical record numbers, and room identifiers while preserving care context information such as medication type, administration timing, and workflow state. The governed training output 1040 delivers anonymized data 1046 suitable for training care-scheduling models without exposing protected health information.

### List of Figures and Elements

FIG. 1 illustrates a block diagram of an architecture for generating machine-learning training vectors from execution-envelope-derived field data. FIG. 1 includes execution envelopes 100, intent 102, context 104, telemetry 106, corroboration 108, outcome/exception 110, integrity/provenance 112, transformation pipeline 120, intent extraction 122, telemetry normalization 124, corroboration association 126, vector assembly 128, exception training pipeline 140, deviation detection 142, context snapshot 144, exception tagging 146, exception vector output 148, labeled training vectors 150, aggregated training corpus 160, multi-worker aggregation 162, multi-site aggregation 164, corpus storage 166, machine-learning/autonomous-system training layer 180, model training 182, autonomous control training 184, and inference/policy output 186.

FIG. 2 illustrates a block diagram of an execution envelope serving as a source data primitive for training-vector generation. FIG. 2 includes execution envelope 200, instruction intent 210, instruction identifier 212, instruction version 214, delivered modality 216, target role/worker 218, context data 220, location context 222, time context 224, worker role 226, environmental context 228, telemetry data 230, motion telemetry 232, spatial position 234, execution window 236, sensor metadata 238, corroborating signals 240, witness signatures 242, workflow confirmation 244, tool/interlock state 246, biometric/device context 248, outcome state 250, execution state 252, completion/closure data 254, outcome tags 256, exception state 260, deviation flag 262, override/bypass data 264, exception tag 266, context snapshot 268, integrity/provenance 270, integrity data 272, source envelope ID 274, timestamp/trace data 276, lineage metadata 278, and training-vector generation 280.

FIG. 3 illustrates a diagram of an execution-window timeline associated with a delivered instruction. FIG. 3 includes instruction delivery 300, intent datum 302, instruction identifier 304, delivery time 306, execution/telemetry window 320, window open 322, telemetry capture 324, spatial position capture 326, corroborating signal capture 328, outcome/exception capture 330, envelope closure 340, window close 342, closure timestamp 344, envelope finalization 346, derived training vector 360, intent field 362, action field 364, corroboration field 366, and output vector 368.

FIG. 4 illustrates a block diagram of a system for transforming intent, telemetry, and corroborating signals into a labeled training vector. FIG. 4 includes intent data 400, instruction identifier 402, instruction version 404, intent datum 406, telemetry data 420, motion telemetry 422, spatial position 424, execution-window data 426, corroborating signals 440, witness signatures 442, workflow confirmation 444, interlock/device state 446, outcome/exception tags 460, outcome tag 462, exception tag 464, closure state 466, vector assembly engine 480, normalization 482, association 484, labeling 486, vector construction 488, labeled training vector 500, intent field 502, action field 504, corroboration field 506, and outcome/exception field 508.

FIG. 5 illustrates a flowchart of a method for generating a machine-learning-ready training vector from execution-envelope-derived data. FIG. 5 includes method 550, step 552 for capturing instruction delivery, instruction identifier 553, step 554 for establishing an intent datum, intent data 555, step 556 for opening an execution window, bounded telemetry interval 557, step 558 for capturing telemetry, motion data 559a, spatial position 559b, step 560 for collecting corroborating signals, witness signatures 561a, workflow/interlock state 561b, step 562 for associating outcome or exception data, outcome tag 563a, exception tag 563b, step 564 for transforming captured data, normalization 565a, association 565b, labeling 565c, step 566 for generating a labeled training vector, intent field 567a, action field 567b, corroboration field 567c, outcome/exception field 567d, and step 568 for outputting a machine-learning-ready record.

FIG. 6 illustrates a flowchart of a method for generating exception-tagged deviation training records. FIG. 6 includes method 600, step 602 for detecting a worker deviation event, manual override 603a, interlock bypass 603b, instruction deviation 603c, step 604 for identifying the override, bypass, or instruction deviation, deviation type 605, step 606 for capturing a context snapshot, timestamp 607a, execution context 607b, step 608 for capturing spatial and environmental conditions, location context 609a, environmental conditions 609b, interlock state 609c, step 610 for associating the deviation with a source instruction, instruction identifier 611a, execution envelope reference 611b, step 612 for generating an exception-tagged record, exception tag 613a, context snapshot 613b, deviation metadata 613c, step 614 for providing exception training input, and predictive model input 615.

FIG. 7 illustrates a diagram of a structured exception-tagged deviation record generated from a worker deviation event. FIG. 7 includes exception-tagged deviation record 700, source instruction 710, instruction identifier 712, instruction version 714, intent datum 716, deviation type 720, override event 722, bypass event 724, instruction deviation 726, environmental context 730, ambient conditions 732, equipment state 734, time context 736, spatial context 740, location context 742, zone/room/asset 744, position snapshot 746, interlock/workflow state 750, interlock state 752, workflow state 754, dependency state 756, worker rationale 760, worker input 762, voice/text note 764, optional justification 766, exception label 770, exception tag 772, training classification 774, adaptive model input 776, and exception training pipeline 780.

FIG. 8 illustrates a system diagram depicting aggregation of labeled training vectors into an execution training corpus. FIG. 8 includes Labeled Training Vector 800a, Worker A 802a, Task Type A 804a, Site A 806a, Labeled Training Vector 800b, Worker B 802b, Task Type B 804b, Site A 806b, Labeled Training Vector 800c, Worker C 802c, Task Type C 804c, Site B 806c, Labeled Training Vector 800d, Worker D 802d, Task Type D 804d, Site C 806d, Corpus Aggregation Engine 820, Normalization 822, Cross-Record Association 824, Corpus Assembly 826, Partitioning/Indexing 828, Execution Training Corpus 840, Multi-Worker Records 842, Multi-Task Records 844, Multi-Site Records 846, and Corpus Output 848.

FIG. 9 illustrates a block diagram of a system for training a machine-learning model using an aggregated execution training corpus. FIG. 9 includes execution training corpus 900, intent-action records 902, corroboration data 904, exception records 906, corpus metadata 908, training input/ingestion layer 920, corpus selection 922, vector loading 924, training partitioning 926, input preparation 928, model/control training engine 940, model training 942, policy learning 944, weight/parameter update 946, training iteration 948, trained machine-learning/autonomous control system 960, trained model 962, control policy 964, and inference/execution output 966.

FIG. 10 illustrates a block diagram of a governance layer and provenance layer associated with an execution training corpus. FIG. 10 includes execution training corpus 1000, training records 1002, exception records 1004, source envelope references 1006, corpus metadata 1008, governance/provenance layer 1020, traceability module 1022, confidence weighting module 1024, privacy controls 1026, integrity validation 1028, provenance handling 1030, anonymization/tokenization 1032, governed training output 1040, traceable records 1042, weighted training inputs 1044, anonymized data 1046, and controlled training access 1048.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method comprising:
capturing, by a computing system, an instruction delivered to a worker, wherein the instruction includes an instruction identifier;
establishing, by the computing system, an intent datum associated with the instruction, the intent datum representing information sufficient to establish what the worker is being asked to do;
opening, by the computing system, an execution window defining a bounded telemetry interval associated with the instruction;
capturing, by the computing system, telemetry data during the execution window, the telemetry data including at least motion data and spatial position data;
collecting, by the computing system, one or more corroborating signals during the execution window, the one or more corroborating signals including at least one of witness signatures, workflow confirmations, tool state, interlock state, biometric state, or outcome tags;
associating, by the computing system, outcome data or exception data with the captured telemetry data; and
generating, by the computing system, a labeled training vector that links the intent datum to the telemetry data and the one or more corroborating signals, the labeled training vector including an intent field, an action field, a corroboration field, and an outcome/exception field.

2. The method of claim 1, further comprising:
normalizing, by the computing system, the telemetry data into a standardized format prior to generating the labeled training vector.

3. The method of claim 1, wherein the telemetry data further includes sensor metadata containing descriptive information about sensors used to capture the telemetry data.

4. The method of claim 1, wherein the one or more corroborating signals include a workflow confirmation from a workflow system or process management system that corroborates task execution.

5. The method of claim 1, wherein the one or more corroborating signals include an interlock state capturing a state of a safety interlock associated with a work event.

6. The method of claim 1, further comprising:
closing, by the computing system, the execution window upon task completion or envelope closure;
recording, by the computing system, a closure timestamp indicating when the execution window terminated; and
finalizing, by the computing system, an execution envelope containing the intent datum, the telemetry data, the one or more corroborating signals, and the outcome data or exception data.

7. The method of claim 1, further comprising:
associating, by the computing system, integrity data with the labeled training vector, the integrity data enabling verification that the labeled training vector has not been altered after creation.

8. The method of claim 1, further comprising:
outputting, by the computing system, the labeled training vector as a machine-learning-ready record for use in training a machine-learning model or an autonomous control system.

9. A method comprising:
detecting, by a computing system, a worker deviation event, wherein the worker deviation event includes at least one of a manual override of a procedural step, a bypass of a safety interlock, or a departure from a delivered instruction;
identifying, by the computing system, a deviation type associated with the worker deviation event;
capturing, by the computing system, a context snapshot at a moment of the worker deviation event, the context snapshot including a timestamp and an execution context;
capturing, by the computing system, spatial and environmental conditions present at the moment of the worker deviation event, the spatial and environmental conditions including location context, environmental conditions, and interlock state;
associating, by the computing system, the worker deviation event with a source instruction via an instruction identifier and an execution envelope reference; and
generating, by the computing system, an exception-tagged deviation record including an exception tag identifying the worker deviation event as an exception-type training example, the context snapshot, and deviation metadata.

10. The method of claim 9, further comprising:
providing, by the computing system, the exception-tagged deviation record as a training input for a predictive model, enabling the predictive model to learn adaptive behaviors from the worker deviation event.

11. The method of claim 9, wherein the deviation type distinguishes between a manual override, an interlock bypass, and an instruction deviation.

12. The method of claim 9, wherein the context snapshot further includes workflow state information indicating where in a prescribed procedure the worker deviation event occurred.

13. The method of claim 9, further comprising:
capturing, by the computing system, worker rationale data associated with the worker deviation event, the worker rationale data including at least one of worker input, a voice note, a text note, or a justification for the worker deviation event.

14. The method of claim 9, wherein the exception-tagged deviation record further includes a training classification that categorizes the worker deviation event for training purposes.

15. A system comprising:
one or more processors; and
one or more non-transitory computer-readable media storing instructions that, when executed by the one or more processors, cause the system to perform operations comprising:
receiving an execution training corpus including intent-action records that link instruction intent to captured telemetry and outcome information, corroboration data including signals supporting confidence in recorded context or action, and exception records including exception-tagged deviation records;
selecting training data from the execution training corpus based on training objectives;
loading the selected training data including the intent-action records, the corroboration data, and the exception records;
partitioning the selected training data into training sets; and
training a machine-learning model or an autonomous control system using instruction-action-corroboration relationships preserved in the selected training data.

16. The system of claim 15, wherein the operations further comprise:
learning a control policy from the selected training data, the control policy governing physical actions, task execution, or operational decision-making.

17. The system of claim 15, wherein the operations further comprise:
weighting training examples based on a level of corroboration associated with each record in the selected training data.

18. The system of claim 15, wherein the execution training corpus includes multi-worker records aggregating training data across multiple workers, multi-task records aggregating training data across different task types, and multi-site records aggregating training data across multiple work sites.

19. The system of claim 15, wherein the operations further comprise:
validating integrity of records in the execution training corpus by verifying that the records have not been altered after creation; and
assigning confidence weights to the records based on quantity, quality, or type of corroborating signals associated with the records.

20. The system of claim 15, wherein the operations further comprise:
anonymizing personally identifying information associated with workers, devices, or sites in the execution training corpus while preserving usefulness of the training data for training the machine-learning model or the autonomous control system.
